(19) United States
(12) Patent Application Publication
(10) Pub. No.: US 2025/0324107 A1
(43) Pub. Date: Oct. 16, 2025

(54) SYSTEM & METHOD FOR BROADCASTING TO SELECTED USER GROUPS USING MOBILE COMMUNICATION DEVICES

(71) Applicant: 3RD-I TECHNOLOGY INC., CHESTER, NJ (US)

(72) Inventor: Dillon Abend, Chester, NJ (US)

(21) Appl. No.: 19/228,408

(22) Filed: Jun. 4, 2025

Related U.S. Application Data
(63) Continuation-in-part of application No. 19/177,266, filed on Apr. 11, 2025.
(60) Provisional application No. 63/632,568, filed on Apr. 11, 2024.
(60) Provisional application No. 63/655,800, filed on Jun. 4, 2024.

(51) Int. Cl. H04N 21/2187; H04N 21/4788; H04N 21/8549

(52) U.S. Cl. CPC H04N 21/2187; H04N 21/4788; H04N 21/8549

(57) ABSTRACT

A system and method for broadcasting live multimedia to predefined social groups (squads), may include selecting one or more squads in a client application, initiating a live broadcast session capturing and transmitting a first and second video streams from a first and second camera and an environmental audio stream, initiating a push notification to members of the selected squads, issuing a secondary nudge alert to the members of the selected squad who do not join within a configurable time threshold, and upon session termination, storing a recording of the video and audio.

### CROSS-REFERENCE TO RELATED APPLICATIONS

This application claims the benefit of U.S. Provisional Application No. 63/655,800, filed Jun. 4, 2024 the disclosure of which is hereby incorporated herein by reference in its entirety. This is also a continuation-in-part of U.S. patent application Ser. No. 19/177,266, filed Apr. 11, 2025, which claims the benefit of U.S. Provisional Application No. 63/632,568 filed Apr. 11, 2024, the disclosure of which is hereby incorporated herein by reference in its entirety.

### FIELD OF THE INVENTION

The present invention relates generally to social multimedia communication systems and, more particularly, to methods and apparatus for live streaming video, audio, and location data to predefined groups (“Squads”), recording and archiving such streams, and providing interactive in-stream messaging, trip notifications, and emergency alerts.

The present invention also relates to the field of digital video recording and broadcasting, specifically a system and method enabling real-time video uploads with dual camera capabilities during recording. This system offers continuous accessibility through a single persistent link, allowing for immediate access to both short and long-duration videos. This innovation transforms the video-sharing space by enabling users to send and watch long-duration videos within seconds of a livestream or recording, eliminating the need to download and share large files, which is often time consuming and impractical for larger files and to watch a dual-camera livestream in real time.

The present invention also relates to the field of mobile safety systems and emergency alert technologies. More particularly, it relates to systems and methods for discreetly initiating and maintaining real-time, multimedia emergency broadcasts via mobile communication devices, enabling passive activation, secure transmission, and dispatcher access in high-risk or constrained environments.

### BACKGROUND OF THE INVENTION

Existing social platforms often silo text chat, live video, and location sharing into separate services. Users must switch between apps to broadcast live video, alert friends, record sessions, or share travel routes and arrival times. Moreover, current solutions lack seamless group-based emergency alerting and dual-camera broadcasting, and they do not automatically remind absent viewers to join.

Accordingly, there is a need for an integrated system that enables a user to GO LIVE to one or more Squads with a single action, supports real-time interactive messaging, sends “nudge” reminders, records completed sessions with transcripts and summaries, shares live travel routes with ETA notifications, and issues emergency alerts to designated groups.

Moreover, in the realm of digital broadcasting and video sharing, users frequently encounter the inconvenience of managing multiple links for live and archived content, leading to a fragmented user experience and complicating the content-sharing process. Streamers are currently using multiple phones or camera angles to capture the video of them and the video in front of them. Additionally, there is a growing demand for more interactive and versatile live broadcasting features, such as dual camera usage and post-broadcast accessibility. Sharing videos longer than a few minutes often takes a considerable amount of time or fails entirely due to file size limitations.

Despite the proliferation of personal safety applications, many still rely on overt actions by users-such as dialing emergency services or verbally requesting help. These methods may escalate threats or be impossible in rapidly unfolding emergencies. Moreover, current systems lack contextual real-time data, such as visual/audio feeds or precise location tracking, and few provide reliable ways to notify emergency responders without detection.

There is a substantial unmet need for a system that enables users to discreetly activate a comprehensive emergency response mechanism—one that integrates live dual-camera video, continuous location updates, audio feeds, autonomous threat detection, and secure cloud storage—without the need for vocalization, app unlocking, or visible interaction.

### SUMMARY OF THE INVENTION

The following presents a simplified summary of the disclosure in order to provide a basic understanding of some aspects of the various embodiments disclosed herein. This summary is not an extensive overview of every detail of every embodiment. It is intended to neither identify key or critical elements of every embodiment nor delineate the scope of every disclosed embodiment. Its sole purpose is to present some concepts of disclosure in a simplified form as a prelude to the more detailed description that is presented later.

In an embodiment, a method for broadcasting live multimedia to predefined social groups (squads), may include selecting one or more squads in a client application, where each of the squads may include one or more members, initiating a live broadcast session capturing and transmitting a first and second video streams from a first and second camera and an environmental audio stream, initiating a push notification to members of the selected one or more squads, and upon termination of the live broadcast session, archiving the live broadcast session. The archiving of the live broadcast session may include storing a recording of the video and audio, a text transcript, and an AI-generated summary.

In an embodiment, a system for social live broadcasting, may include a client application installed on a user device, the client application configured to capture dual-camera video, audio, and GPS location; a backend server configured to manage session credentials, direct media streams, generate speech-to-text transcripts and AI summaries, and store session data; a notification service configured to send push, SMS, and in-app alerts for the initiation of a live broadcast, nudge alerts, trip alerts, arrival alerts, and emergency events; and a data store for persisting recorded media, transcripts, summaries, and route data.

### BRIEF DESCRIPTION OF THE DRAWINGS

The drawings set forth exemplary embodiments of the disclosed concepts and are not intended to be limiting in any way.

FIG. 1 illustrates a system architecture diagram for a safety system in accordance with the disclosed concepts.

FIG. 2 illustrates is a flow diagram of user input modalities and their respective activation triggers to initiate a potential emergency session.

FIG. 3 illustrates flow diagram for communication between the user and a remote dispatcher, for emergency escalation.

FIG. 4 is a flow diagram showing the broadcasting of the live streamed location information to viewers.

FIG. 5 illustrates a method for increasing a user's safety by providing an application allowing for the initiation of potential emergency sessions.

FIG. 6 illustrates a system diagram for a system for rider safety in accordance with the disclosed concepts.

FIG. 7 illustrates a user device that may be used with the systems and methods of FIGS. 1-6.

FIG. 8 illustrates a graphical user interface layout for a dashboard in accordance with the disclosed concepts.

FIG. 9 illustrates a block diagram of a system architecture in accordance with the disclosed concepts.

FIG. 10 illustrates flow diagram for a method for distributing a live broadcast session in accordance with the disclosed concepts.

FIG. 11 illustrates a flow diagram for a method for initiating a trip mode broadcast in accordance with the disclosed concepts.

FIG. 12 illustrates a flow diagram for a method for initiating an emergency alert in accordance with the disclosed concepts.

FIG. 13 illustrates a flow diagram for a system for live broadcasting and archival in accordance with the disclosed concepts.

FIG. 14 illustrates a flow diagram for a method for continuous video recording and live broadcasting

### DETAILED DESCRIPTION OF THE INVENTION

The following detailed description and the appended drawings describe and illustrate exemplary embodiments solely for the purpose of enabling one of ordinary skill in the relevant art to make and use the invention. As such, the detailed description and illustration of these embodiments are purely exemplary in nature and are in no way intended to limit the scope of the invention, or its protection, in any manner. It should also be understood that the drawings are not to scale and in certain instances details have been omitted, which are not necessary for an understanding of the present invention, such as conventional details of fabrication and assembly.

In an embodiment, a method for broadcasting live multimedia to predefined social groups (squads), may include selecting one or more squads in a client application, where each of the squads may include one or more members, initiating a live broadcast session capturing and transmitting a first and second video streams from a first and second camera and an environmental audio stream, initiating a push notification to members of the selected one or more squads, and upon termination of the live broadcast session, archiving the live broadcast session. The archiving of the live broadcast session may include storing a recording of the video and audio, a text transcript, and an AI-generated summary.

In certain embodiments the first and second cameras may be front-facing and rear-facing cameras, and the first and second video streams are captured simultaneously. In certain embodiments, the method may further include engaging trip mode, which may include specifying current location and a destination, computing an estimated time of arrival, transmitting a GPS location stream and corresponding time stamp stream as part of the live broadcast session, notifying the selected squads of trip start and the estimated time of arrival, streaming real-time trip updates showing an actual route made from the GPS location stream as part of the live broadcast session, issuing an arrival notification upon reaching the destination reach. The archiving the live broadcast session may further include archiving a trip recording, which may include the planned route, the actual route, the gps location stream and corresponding time stamp stream. The selected squads may be provided access to the archived broadcast session, including the trip recording.

In certain embodiments, the method may further include issuing an emergency alert during the session that dispatches a high-priority notification with live location and stream access links to the selected squads. In certain embodiments, the method may further include generating and associating a persistent access link with the live broadcast such that during the live broadcast the persistent access link provides access to the live broadcast, including the first and second video streams, the environmental audio stream, and after the live broadcast session, the persistent access link provides access to the archived broadcast, including the recording of the video streams and audio stream, the text transcript, and the AI-generated summary. In certain embodiments, the method may further include generating and associating a persistent access link with the live broadcast session such that during the live broadcast the persistent access link provides access to the live broadcast session, including the first and second video streams, the environmental audio stream, the planned route, the actual route, the GPS location stream and corresponding time stamp stream, and after the broadcast session, the persistent access link provides access to the archived broadcast, including the recordings of the first and second video streams and the audio stream, the planned route and the actual route, the GPS location stream and corresponding time stamp stream. In certain embodiments, the persistent access link may present the first and second video streams in a dual-camera split-screen format.

In certain embodiments, the method may further include a messaging interface that allows real-time communication between the broadcaster and squad members. In certain embodiments, the method may further include the allowing viewers to react or respond via the messaging interface during the live stream. In certain embodiments the first and second video streams may be encoded using a compression algorithm selected from the group consisting of H.264, H.265, or VP9. In certain embodiments, the method may further include receiving confirmation when the members of the selected squads join the live broadcast session, and providing a user interface button for initiating a secondary nudge alert to the members of the selected squad who have not joined the broadcast session. In certain embodiments, the method may further include receiving confirmation when the members of the selected squads join the live broadcast session, and issuing a secondary nudge alert to the members of the selected squad who do not join within a configurable time threshold. In certain embodiments, the persistent access link may include an optional expiration timestamp or access token. In certain embodiments, the application may further be configured to record timestamp metadata during the video session. In certain embodiments, the method may further include generating a summarized video highlight reel using artificial intelligence.

In certain embodiments, the access permissions for the persistent link may be managed through a user account. In certain embodiments, a viewer interface may be provided with the persistent access link allows switching between single and dual-camera viewing modes. In certain embodiments, the method may further include using edge computing or local caching to reduce latency in long-duration video playback. In certain embodiments, the dual video streams may be displayed side-by-side in a split-screen format on a web or mobile interface. In certain embodiments, the first and second video streams may be displayed in picture-in-picture format on a web or mobile interface.

In an embodiment, a system for social live broadcasting, may include a client application installed on a user device, the client application configured to capture dual-camera video, audio, and GPS location; a backend server configured to manage session credentials, direct media streams, generate speech-to-text transcripts and AI summaries, and store session data; a notification service configured to send push, SMS, and in-app alerts for the initiation of a live broadcast, nudge alerts, trip alerts, arrival alerts, and emergency events; and a data store for persisting recorded media, transcripts, summaries, and route data.

In an embodiment, a non-transitory medium may be provided with a set of instructions that when executed by a processor, cause the processor to perform any of the methods described above.

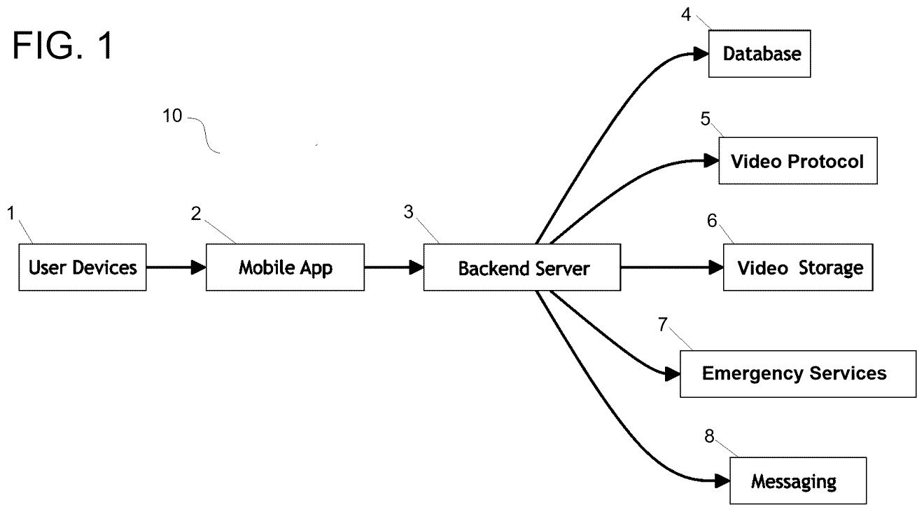

One use of the disclosed concepts relates to the personal safety space. FIG. 1 illustrates a system architecture diagram for a system for social broadcasting safety 10 comprising a mobile application 2 designed to run on user device 1, and backend server 3. The user device 1 may be any suitable device, preferably having both a forward facing camera and a rearward facing camera, a microphone, and a GPS receiver. The mobile application 2, as described in greater detail below, may be capable of communicating with the backend server to initiate potential emergency sessions, escalations to an emergency response request, enable communications, facilitate simultaneous recording of video streams from both the forward-facing and rearward-facing cameras on the user device, and facilitate communication recording and transmitting video streams, an audio stream captured by the user device 1's microphone, a the user device's GPS location data in real time, for recording and/or processing by the back end server. 3

The backend server, as described in greater detail below may facilitate communication between the user and a remote dispatcher/monitoring center, requests for emergency response by authorities that are local to the user, and coordination of the delivery of the data streams recorded by the user the remote dispatcher/monitoring center, local authorities, and/or to the proper third party viewers. The backend server 3 may communicate with, or control communications with a database 4, a video protocol 5, a video storage service 6, an emergency services provider 7, and a messaging system 8 The database 4 may be any suitable database system known in the art or to be developed that may be used for storage of all relevant data received during such incidents, including, but not limited to, user information, such as name, number, description, photographs, address, etc. user preferences, such as escalation thresholds and logic, time-to-escalate rules, non-response triggers, escalation to professional monitoring services, viewer lists, timing settings, etc., session information, including the start time, all inputs received from the user, and the timing related to same, all responses and notifications sent to the user during the session, and any other information that may be useful.

The video protocol 5 may be any suitable video protocol known in the art or to be developed that can be used to record, encode, compress and transmit a live-stream video feed, including but not limited to the Agora Video SDK. The video protocol may be available to both the mobile application 2 and the backend server 3, and the backend server 3 may control pushing updates to the video protocol 5 to the mobile application 2. The video storage service 6 may be any suitable storage location known in the art or to be developed, that can store and make available both the live stream data captured during the sessions, and the complete copies of same kept after the sessions have been completed. The emergency services protocol 7 may be a remote dispatcher or monitoring service, or a protocol for communicating to same, such as the NoonLight API, or any other such protocol or system known in the art or to be developed. It may provide services for communicating with the user during potential emergency sessions, and/or during escalations to an emergency response request. The messaging system 8 may be any suitable messaging system, including but not limited to Firebase Cloud messaging, SMS messaging, and any other messaging systems known in the art or to be developed. This messaging system may be used to provide the user feedback relating to the success of certain actions, such as initiating a potential emergency session, escalating such a session to a request for emergency response, status updates regarding the stages of an emergency response, communication between the user and a remote dispatcher/monitoring center, communications between law enforcement and the user, and any other messages that may be needed.

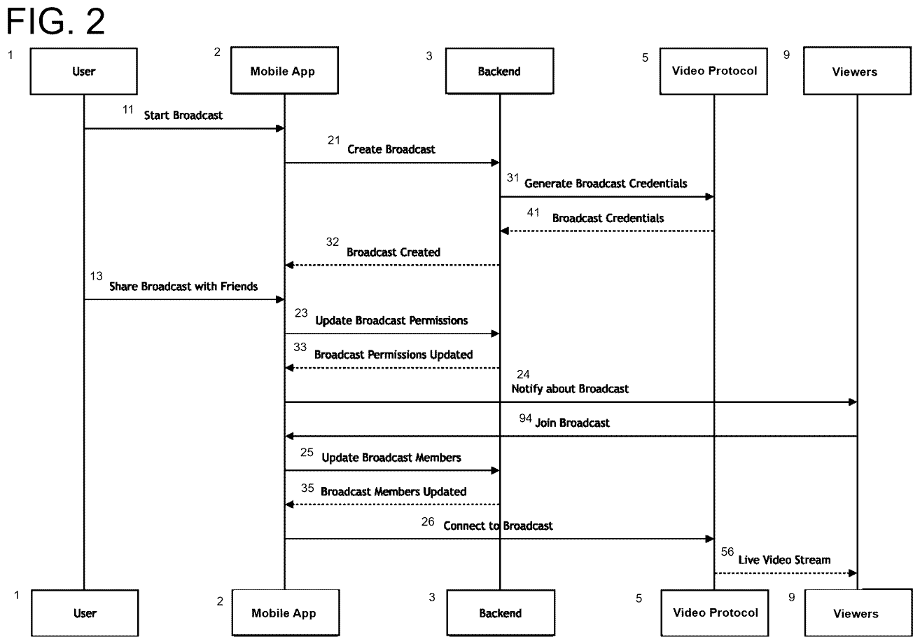

FIG. 2 illustrates is a flow diagram of user input modalities and their respective activation triggers to initiate a potential emergency session in a system 10 in accordance with the disclosed concepts. A user may use their user device 1 to initiate a request to initiate a potential emergency session and start a broadcast 11 on the mobile application 2. The request to initiate a potential emergency session/start a broadcast 11 may be made through any suitable input known in the art or to be developed, including but not limited to activation via widget taps on the mobile application 2, shake gestures employed on the user device 1, spoken safe words captured by the microphone, particular button combinations (these may be hardware, such as hitting the volume buttons in a particular sequence, or software, such as “dialing” a number on a touch screen that looks like a phone dialing screen), or peripheral device/external accessories such as wearable devices with a BlueTooth or other suitable connection to the user device that can send a signal to the application to initiate a potential emergency session/start a broadcast 11 when a button is pressed or other input is made on the wearable device. The mobile application may have a user interface that mimics the user device's normal phone screen, a texting application, another application, such as a game or video streaming application, in order to allow the user to discreetly provide activation input if they are in potentially dangerous circumstances. For example, the mobile application may provide visual or haptic feedback to the user confirming successful initiation of a potential emergency session and transmission of emergency data streams to a remote dispatcher or monitoring center, without exposing the activity to observers. Upon receiving initiating input, the mobile application 2 may create a broadcast request 21 from the backend server 3. The mobile application may further activate the user device's forward facing and rearward facing cameras, and simultaneously begin recording a video stream on each. The mobile application may further begin recording one or more audio streams using its microphones, either separately or integrating into one or both video streams, and may further begin recording user device geo-location data from the device's GPS receiver. The mobile application may periodically packetize and transmit emergency streaming data, including but not limited to the front and rear video streams, the audio stream and the stream of GPS geo-location data. Other data may be included in the emergency streaming data, including time stamps, and information about how the phone is being held, heart rate and other biometric data provided by Bluetooth devices, such as a smart watch or a heart rate monitor. Once the potential emergency session is initiated, it may be maintained by the mobile application 2 until the user enters a particular input, such as a security pin, so that other people, such as an aggressor, cannot end it. Similarly, the mobile application may continue to run in the background, even when minimized, continuing to transmit the video, audio and location data when the mobile application 2 is not visible on the user device's 1 display. The mobile application 2 may also run in a semi-minimized state, such as a picture-in-picture format, allowing the user to continue to use the application in a portion of the user device display, while the device can be used normally outside of that picture-in-picture window.

When a request to create a broadcast 21 is received by the backend server 3, It may generate a request for broadcast credentials 31 using a video protocol 5, which may provide the backend server 3 with broadcast credentials 41. Upon successfully receiving same, the backend server 3 may notify the mobile application that the broadcast has been received. The mobile application 2 may provide the emergency streaming data to the backend server 3 for distribution and processing, or it may directly provide the emergency streaming data to the video storage 6 location, where it may be accessible by the backend server 3. The backend server 3 provides the mobile application with a broadcast created notification 32 that may be communicated to the user through visual, haptic, or other suitable feedback, such as vibrations. While auditory feedback may be used with the disclosed concepts, one of the features of system 10 is that it can be implemented to work completely silently and discreetly. Audio feedback may be heard and recognized by a belligerent causing dangerous circumstances, but haptic and visual feedback can be designed to mimic the ordinary usage of the user device, such as receiving normal text messages or application notifications. The backend server 3 may further provide processing on the emergency streaming data. For example, it may monitor and use voice recognition software to detect additional key words in the audio stream, which can be used for escalating a potential emergency session into an emergency response request, or for deescalating or deactivating such a request or session. Additionally, the backend server, or a separate processing module or resource, may be provided with an AI model trained on processing emergency streaming data, and to recognize dangerous circumstances from either video stream, or from the audio stream, or from a combination of both. Such an AI model could be trained from a database of past incidents where video or audio feeds are available. Any suitable method of training such an AI model, and any suitable AI model known in the art or to be developed may be used

A user may further initiate an input to share the broadcast with friends 13 on the application. In doing so, they may select the friends with which to share the broadcast, or they may have a pre-selected set of friends identified in their user preferences on the mobile application 2. Upon a request to share the broadcast with friends 13, the mobile application 2 passes the request along to the backend server, along with any updated broadcast permissions 23 provided with a request, such as a user list of friends to receive the broadcast notification. Accordingly, the mobile application 2 may allow the user to send a ‘nudge’ notification to specific contacts to encourage them to join the emergency stream. The backend server 3 may then communicate a broadcast permission updated 33 success message to the mobile application 2, which may notify the user of same through visual, haptic, or other feedback. The backend server may further generate notifications to inform the desired viewers 9 of the broadcast of the user's emergency stream. This may include sending a mobile application 2 message notifying the viewer about the broadcast 24, or it may involve sending an SMS message to the viewer with a link to open the user's broadcast emergency data streams either with the mobile application 2 or via a website. Regardless of how the notification is made, the viewer 9 may join the broadcast 94, by following the link to the mobile application 2 or website where the stream is made available. The mobile application 2 may provide the back end server with an update broadcast members notification 25 indicating that the viewer 9 has commenced watching the user's broadcast. The backend server may then provide the viewer 9's mobile application 2 with a broadcast members updated notification 35 indicating that they have successfully joined the broadcast, and then connect the viewer 9 to the broadcast 26 using the video protocol 5, which may accessing the stream from the video storage 6 or a mirror for same which will provide the live video stream 56 to the viewers 9. The mobile application 2 may allow the viewers to communicate with the user via the messaging system 8, or the viewers 9 may reach out to the user via phone or text communications.

The mobile application 2 may be implemented to poll device connectivity, checking to see whether the user device it has sufficient connection and bandwidth to communicate with the back end server and transmit the emergency data streams. If bandwidth or connectivity becomes an issue, the mobile application may adjust the encoding of the video and audio streams to require less data (or use more data when bandwidth is not at issue), and may further initiate fallback SMS messaging when connectivity is interrupted. The SMS messages may continue to contain location data, and may be used to communicate between the mobile application 2 and the backend server 3, as well as to allow the user to communicate with the emergency services protocol 7 or local dispatch 75.

The mobile application may allow the user to set a variety of user preferences that govern how the application works and who gets notified of potential emergency sessions and requests for emergency response. Such user preferences may include, without limitation, the following: lists of contacts to be notified when a potential emergency session is initiated an the manner of notification to be sent to those contacts (“nudge” notifications, alarms, in-app messages, SMS notifications, etc.); lists of contacts to be notified when an emergency response request is made, and the manner of notification; escalation thresholds and logic such as whether the user should initiate escalations or if escalations should be initiated if the user stops responding or using the mobile application, the frequency with which the mobile application should present response check prompts, time-to-escalate rules setting the timing for escalation due to non-responsiveness or based on user input (for example the user may set an emergency response to require two button presses within a one second window, non-response triggers (such as how many missed status checks should be allowed before escalating to an emergency response request, and the timing between such checks after a failed response), and preferences on the circumstances for escalation to professional monitoring services and what services should be notified.

The mobile application 2 may be linked to a ride-hailing or transportation service platform, such as Uber, Lyft, or a taxi company, or similar services. The mobile application 2 or the backend server 3 may be implemented to initiate potential emergency session automatically if the user deviates from a predetermined route or cancels a destination unexpectedly. In such circumstances the mobile application may prompt the user with a status check, and may initiate the session if the user does not respond. The backend server 3 may also initiate a session using the driver's mobile application 2 on the driver's mobile device 3. Importantly, this system can also be used to increase driver safety from unruly passengers.

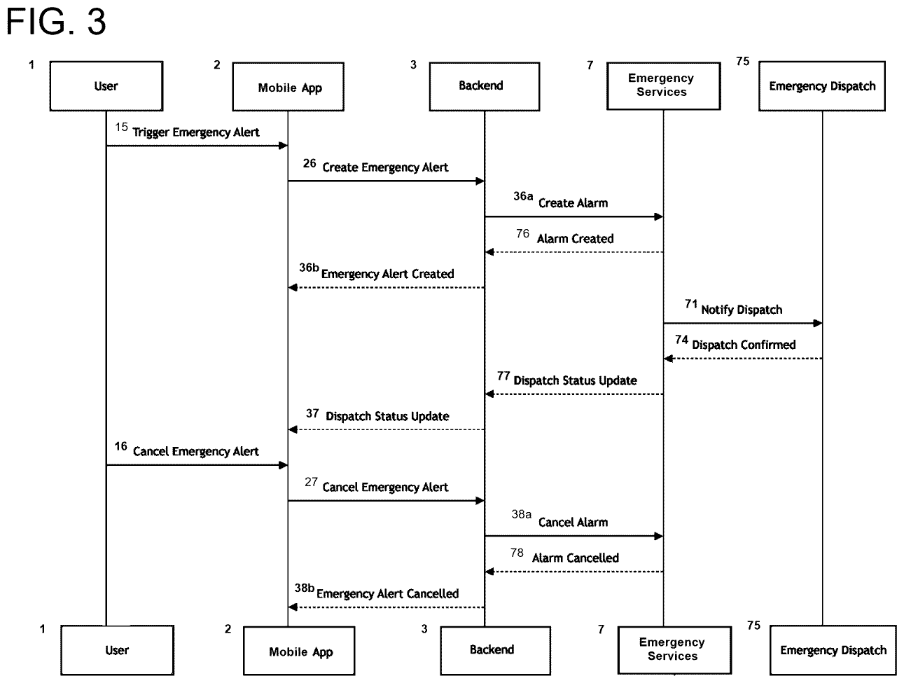

FIG. 3 illustrates flow diagram for communication between the user and a remote dispatcher, for emergency escalation using the system 10. A user may use their user device 1 to trigger an emergency alert 15. Triggering an emergency alert 15 may happen in a variety of ways. The user may manually trigger the emergency alert 15 by hitting a widget or a button on the application. Alternatively, the user may say a safe word set to trigger the emergency alert 15. The user may make a gesture with the user device 1, or hit a button or other input on a wearable device that is in BlueTooth, or other communication with the user device 1. Other methods of triggering an emergency alert may not require the user's input. For example, an AI model, as described above may be trained to detect dangerous circumstances from a video or audio feed, and may be monitoring a live stream broadcast either on the backend server 3 or on the user's device 1 via the mobile application 2. The mobile application 2 may be set to monitor a biometric reading, such as the user's heart rate, and may automatically trigger an emergency response rate if the heart rate spikes, drops below a threshold, or displays an irregular rhythm. Importantly, such triggers may occur even when a potential emergency session is not active and may lead to activation of both a potential emergency session and a request for emergency response at the same time. However triggered, the mobile application 2 may create an emergency alert 26, requesting an emergency response from local authorities. The backend server 3, upon receiving same, may create an alarm 36a and communicate the alarm to an emergency services service or protocol, such as a remote dispatcher or monitoring service, or using a protocol like the NoonLight API. The alarm may be passed along to an administrator at the remote dispatcher/monitoring service, who may locate the appropriate authorities and make an emergency response request to them. Alternatively this may be handled automatically and programmatically, and the emergency services protocol 7 may directly notify dispatch 71 by sending a notification and the relevant evidence, which may include the emergency data stream, and any collected metadata, a transcript of the audio stream prepared via a text-to-speech program, and/or a summary of same generated by a trained large language model AI. The emergency services protocol or service 7 may confirm that an alarm has been created 76 to the backend server 3, which in turn ay notify the mobile application 2 that the emergency alert has been created 36b, which may then provide feedback to the user's device via visual, haptic or other suitable feedback. The emergency dispatch service may communicate via the emergency services protocol 7 or may directly communicate with the user via the messaging system 8, an may provide a dispatch confirmed message 74 and/or periodic updates on the status of the emergency response. Dispatch status updates 77 may be provided by the emergency services protocol 7 to the backend server 3, which may then provide a dispatch status update 37 to the mobile application, which may provide visual, haptic, or other suitable feedback to the user's device 1. The create an alarm notification 36a, may also be passed along to selected viewers 9 to notify them of the situation an give them access to the emergency data streams. Their mobile application may receive such a notification and issue a high-priority sound notification using a mobile device's critical alert entitlement framework that bypasses device mute and do-not-disturb states. This alarm notification may include a link to live stream data and user location.

The user may also cancel an emergency alert if they feel the danger has passed, by touching a widget on the screen of the user's user device, saying a keyword/safe word, or through any other suitable method known in the art or to be developed. The mobile application 2 then generates a cancel emergency alert 27 which is sent to the backend server 3. The backend server may then issue a cancel alarm 38a for the emergency services protocol or service 7, which may then notify dispatch 71 that the alarm has been cancelled. Emergency dispatch 75 may then take steps to cancel the emergency response, and issue a dispatch confirm 74, to the emergency services protocol or service 7, which may confirm with an alarm cancelled notification 78 to the backend server 3. The backend server 3 may then issue an emergency alert cancelled notification 38b to the mobile application 2, which can notify the user via visual, haptic, or other suitable feedback.

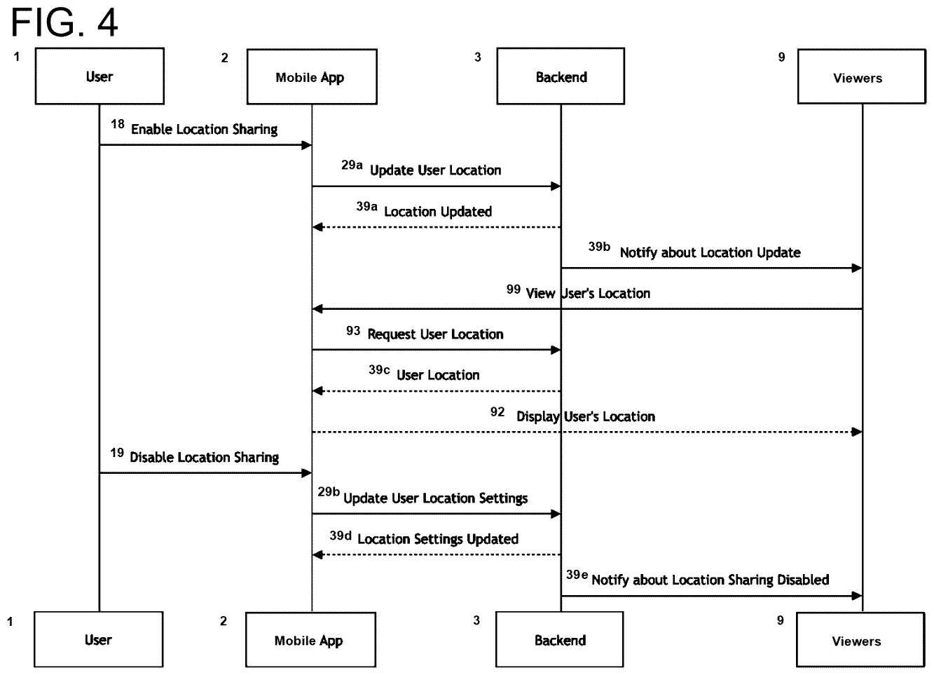

FIG. 4 is a flow diagram showing the broadcasting of the live streamed location information to viewers 9 by the system 10. The location sharing may be used as part of the potential emergency session and/or emergency response methods, described above, or it could be used independently of same. A user may enable location sharing 18 through any of input methods discussed herein, including tapping a widget on the mobile application, using a key word that is detected through a speech to text feature in the application 2, making specific gestures with the user device 1, or hitting a button or other input on a wearable BlueTooth or other wireless device. When location sharing is enabled the mobile application 2 may periodically update the user's location 29a with the backend server 3. The backend server, in turn, may confirm that the location is updated 39a, and may further notify selected viewers 9 about the location update 39b. The location update notification 39b may be through the mobile application 2 on the user's device 1, or may be through SMS or another suitable communication methodology. The viewers 9 may use the mobile application 2 on their user device 1, or may be directed to a website where they can generate a view the user's location 99 request, which may cause their mobile application to request the user's location 93 from the backend server 3 which may then send the user's location 39c to the viewer's 9 mobile application 2, which can then display the user's location 92 by displaying a map with the location highlighted, or through any other methodology for same known in the art or to be developed.

Similarly, a user may disable location sharing 19 by providing input to the mobile application using any of the input methodologies discussed above. This may be done globally for all viewers 9, or on a viewer 9 by viewer 9 basis. The mobile application 2, may generate an update user location settings notification 29b for the backend server instructing the backend to cease further communications relating to the user's location, The backend may confirm the location settings as updated 39d, and may further notify any affected viewers that the user has ceased location sharing 39c.

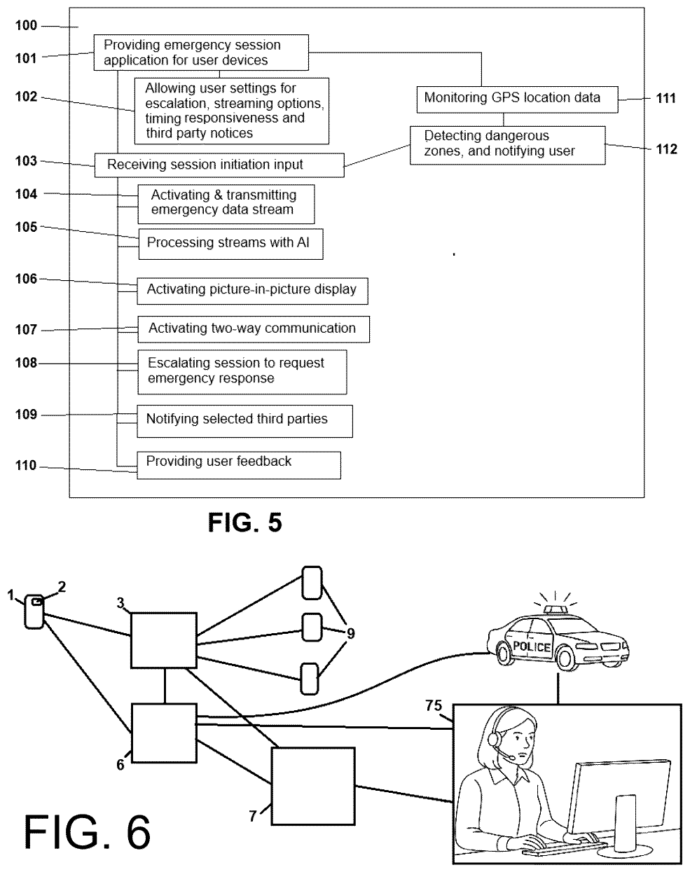

FIG. 5 illustrates a flow diagram for a method for discreetly improving a user's safety 100. The method may include providing an application that allows initiation of potential emergency sessions 101, that can receive session initiation input 103, and may include a passive monitoring feature 111. The application may allow the user a variety of user settings 102, which can allow the user to set circumstances for escalation of a potential emergency session into a request for emergency services, including but not limited to the user's failure to respond to certain prompts, the use of a panic button on the graphical user interface, the use of certain motions or gestures or facial expressions using the rear-facing camera on the mobile device. Other settings may include streaming options, such as what data should be streamed, and whether off-plan data transmission options should used, and when they should be used, the timing settings for when the user should be expected to respond to a prompt, or confirm the initiation of a session, or the like, and the identification of third parties who should receive notices when a potential emergency session or emergency response request is initiated and which data streams those third parties should be given access to.

When the application receives session initiation input 103, it may activate and transit emergency data streams, including but not limited to a first front-facing camera video stream, a second rear-facing camera video stream, an audio stream of environmental audio captured by the mobile device's microphone, and GPS location data from the mobile device's GPS receiver. Other data, such as transcription of the audio via text-to-speech or meta data about time stamps, biometric data (such as heart rate), or device orientation may also be included. The application may also initiate AI review of the emergency data streams on an on-device or remote dispatcher/monitoring center AI model trained to process audio and/or video streams to identify dangerous circumstances. When the AI detects dangerous circumstances it may directly initiate an emergency response from authorities local to the user's location, or it may escalate the potential emergency session to a human for review and authorization of an emergency response request from local authorities.

During a potential emergency session, the device may display application in a semi-minimized picture-in-picture format 106. This may allow for the user to continue to use the phone normally, while also being able to receive notifications and use the mobile application 2. The mobile application would function normally in the smaller window that it is given, and the phone would operate normally when the user manipulates it outside of the application's window. During a potential emergency session, the application may activate two-way communication between the user and the remote dispatcher/monitoring center. During a potential emergency session, the application may provide an interface option to escalate the potential emergency session into a request for emergency response 108 from local authorities. It may do so in response to key words detected in the audio stream, specific gestures with the mobile device, or by the user hitting a panic button.

During a potential emergency session, or when the session is escalated to a request for emergency response, the application may initiate notifications to selected third parties 109, pursuant to the users settings. During a potential emergency session, the application may further provide feedback to the user 110 in the form of a visual cue or haptic feedback to indicate that the potential emergency session has successfully been initiated, to confirm that the data streams are successfully being transmitted, and/or to confirm that a request for emergency response has been successfully initiated.

Passive GPS monitoring 111 may optionally be engaged to detect when the user may be in danger and should consider preemptively activating a potential emergency session. For example, the application may prompt the user when the user enters a GPS neighborhood or zone 112, or the settings may allow the application to automatically initiate a potential emergency session. Such areas may be identified by the user, or by the remote dispatcher/monitoring station, which may set up geo-fenced zones known to be dangerous, and where extra caution should be used. The mobile application 2 may automatically also prompt the user with a pre-alert notification when a vehicular or a pedestrian motion is detected exceeding a predefined threshold, offering the user one-tap access to emergency activation or live streaming, or automatically beginning the session if the user fails to respond, or if other conditions are met (the unusual speed continues for a predefined time, a safe word is detected, etc.)

FIG. 6 illustrates a system for rider safety 10. The system 10 may include a user device 1 on which a mobile application 2 is installed, a backend server 3/monitoring station, a video storage service 6, an emergency services protocol service 7, a local dispatcher 75 and first responders. The mobile application in FIG. 6 is shown in picture-in-picture mode, occupying only a portion of the user device's 1 display, allowing the user device to function normally around the mobile application frame, while allowing the user to use the mobile application and receive notifications on it. The mobile application 2, or client application, allows the user to initiate potential emergency sessions, escalate those into requests for emergency response, transmit emergency streaming data, including video from the front-facing camera, rear-facing camera, an audio stream of audio picked up by the user device's 1 microphone, and a geo-location data stream from the user device's GPS receiver, set user preferences, and perform any of the methods discussed above in greater detail for the mobile application 2. The backend server may act as a monitoring station and may coordinate communication between the mobile application 2, the video storage system 6 and the emergency services protocol service 7, as described above. It may also manage communication to mobile applications on viewer devices 2 and/or provide links to viewer devices through SMS, email or other communication methods to provide them with access to the live streaming data from the user device's 1 mobile application 2 during a potential emergency session and/or during escalation to an emergency response request. It may also perform any of the methods disclosed above for the backend server 3. The video storage service 6 may store and make available for distribution the live stream data, and may store a copy of the full stream once the live stream has finished. The emergency services protocol service 7 may provide an administrator to communicate and monitor the user's situation, handle requests for escalating into a request for emergency response from local authorities, and handle the actual communications to the local authority emergency dispatch 75. Persons of skill in the art will recognize that the disclosed concepts can be implemented in a myriad of ways, and some of these systems may be combined or systems may be separated into separate modules to accomplish the goals of the disclosed concepts within the contemplated scope of same.

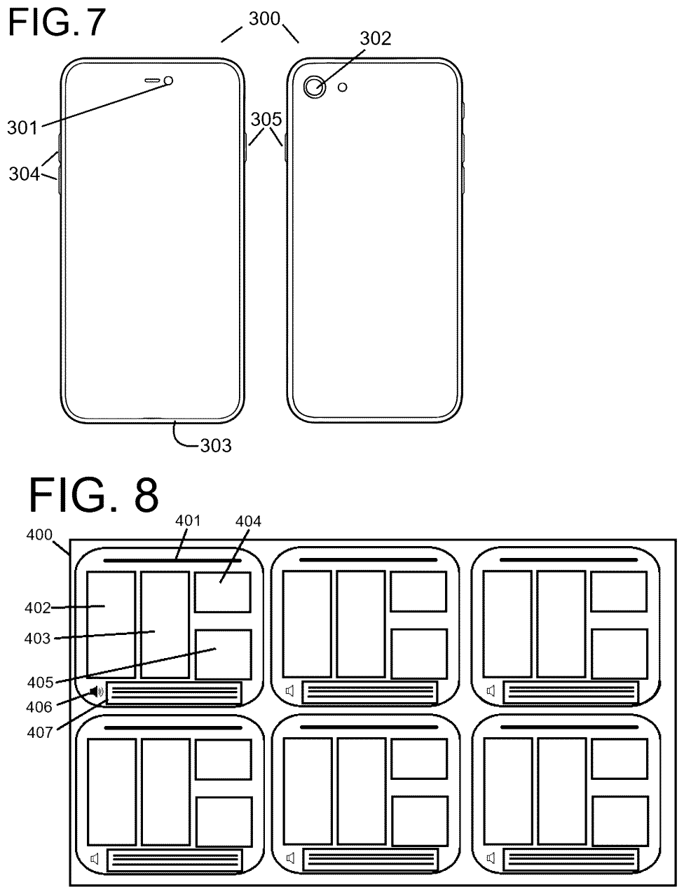

FIG. 7 illustrates a user device 1, 300 that may be used with the systems and methods discussed above. The user device may have a forward facing camera 301, a rear-facing camera 303, one or more microphones 303, hardware buttons, like the volume buttons 304, and a power button 305. It may have a GPS receiver, and hardware and software that allow it to run applications, such as the mobile application 2 described above, and communicate with other computers, such as the backend server 3, via the Internet or a VPN. It may further be provided with BlueTooth and other wireless communications protocols to allow it to connect to external accessories/peripheral devices, such as heart rate monitors, smart watches, emergency buttons, and other such devices, all of which can then be used in accordance with the methods and systems described above.

FIG. 8 illustrates a monitoring system dashboard user interface 400. The dashboard may include a plurality of potential emergency sessions 401. Each may include identifying information 402, a first video stream 403, a second video stream 404, an additional information window 405, a sound control 406 and a message history 407. The identifying information may include the user's name and/or ID number, or any other suitable identifier. The first video stream 403 and second video stream 404 may be the video streams provided by the user device 1, and may be received directly from the user device 1 or from a video storage server 6. The administrator may be able to pause or enable the video for multiple sessions at once. The sound control 406 may allow an administrator to listen to the sounds from a particular session, automatically muting all other sessions. The additional information window 405 may include other information about the user and metadata collected, such as their address, phone number, contact list (i.e. viewers 9 who should be notified), biometric readings, if available, etc. A message window 407 may track all messages exchanged with a user. And may also include a live text feed of the audio stream generated by an AI model or text-to-speech program processing the audio stream.

A proprietary dispatcher interface allows two-way text communication, PIN-based event deactivation, and access to archived stream data. The emergency stream operates in picture-in-picture (PIP) mode, allowing users to multitask while remaining under monitoring. Artificial intelligence-based threat detection may autonomously initiate the emergency state when visual indicators of violence or weaponry are detected.

The backend architecture may include a Node.js server, MongoDB database, AWS S3 media storage, Firebase Cloud Messaging for push alerts, Agora SDK for video transport, and the Noonlight API for emergency responder dispatch. Recordings may be encrypted and retained for a minimum of ninety (90) days to support review or forensic use.

The emergency system may include the following elements:
1. Triggering Mechanisms: Activation via widget taps, shake gestures, safewords, button combinations, or external accessories.
2. Livestreaming: Dual-camera operation capturing user-facing and world-facing perspectives with environmental audio.
3. Geolocation Tracking: Periodic and continuous transmission of location coordinates.
4. Dispatcher Interface: Real-time access to streams, two-way messaging, emergency logging, and user PIN verification.
5. Artificial Intelligence Threat Detection: Mobile-embedded inference engines detect aggressive behavior, firearms, or blades.
6. Cloud Architecture: MongoDB for data, AWS S3 for media, Agora for streaming, and Firebase for messaging.
7. Security Layer: TLS 1.2+encryption, secure token-based authentication, and user-controlled stream deactivation via PIN.
8. Fail-Safe Modes: SMS fallbacks, Wi-Fi triangulation, offline video caching, and reconnection syncing.

The system supports flexible configuration across subscription tiers (basic, enhanced, pro, enterprise) and accommodates different use cases including rideshare trips, campus security, eldercare, domestic violence intervention, and solo travel.

The advantages of systems using the disclosed concepts are as follows:
Enables discreet activation in high-risk scenarios through multiple input methods—voice, gesture, widgets, hardware buttons—ensuring user safety even when speech or overt movement may escalate danger.
Supports dual-camera, real-time visual/audio transmission from both front-and rear-facing lenses, providing dispatchers with a complete situational view for accurate decision-making.
Seamlessly integrates with third-party dispatch platforms such as Noonlight, leveraging pre-existing infrastructure for scalability, legal compliance, and resource coordination.
Delivers AI-based automated activation with on-device inference engines trained on visual indicators of violence, enabling passive protection when a user is incapacitated or unaware.
Offers background and Picture-in-Picture (PIP) streaming modes, allowing users to minimize or exit the app without interrupting the emergency broadcast, preserving both discretion and connectivity.
Sends high-priority sound alerts using native Critical Alerts frameworks that override device mute and Do Not Disturb settings, instantly notifying emergency contacts with location and video access links.
Ensures data continuity through robust fail-safes, including fallback to SMS-based location alerts, offline video caching, auto-resume streaming on reconnection, and Wi-Fi/cell-tower triangulation for location estimation.
Enables cloud-based evidence archiving via MongoDB and AWS S3, retaining timestamped video, audio, messaging, and location metadata for at least 90 days to support post-incident analysis or legal proceedings.
Supports diverse use cases: rideshare safety, university and campus security, eldercare monitoring, domestic violence response, and remote or solo travel safety—making it highly adaptable across industries.
Designed with accessibility and equity in mind, offering voice-guided onboarding, scalable UI for seniors or visually impaired users, and preset contact templates for simplified emergency configuration.
Provides modularity through tiered feature plans (e.g., Basic, Enhanced, Pro, Enterprise), allowing customized feature access based on user needs or institutional deployments.
Offers interoperability with wearables and smart accessories, enabling Bluetooth-based emergency activation via smartwatches, lanyards, or health-monitoring devices. through multiple input methods, including voice, motion, and hardware, reducing user burden in dangerous conditions.
Supports dual-camera, real-time visual/audio transmission, giving responders full environmental context and improving response accuracy.
Seamlessly integrates with emergency dispatch systems and third-party platforms such as Noonlight, expanding the system's reach and interoperability.
Offers AI-based automated activation with on-device inference for real-time threat detection, even when the user is unable to act.
Operates in background/Picture-in-Picture (PIP) mode, allowing the user to multitask or conceal their actions, increasing user safety in escalating scenarios.
Delivers high-priority, device-override alerts using OS-native Critical Alerts frameworks to notify emergency contacts instantly, even during silent or “Do Not Disturb” modes.
Includes robust fail-safes such as offline caching, fallback SMS, and reconnect logic to ensure continuity despite poor connectivity.
Facilitates post-event review through secure, encrypted cloud archival of all emergency session data, supporting legal, insurance, or investigative use cases.
Adapts to multiple use cases—rideshare, campus safety, domestic violence, eldercare—offering wide commercial and social impact.
Designed with accessibility in mind, offering UI flexibility for elderly or mobility-impaired users, voice-guided interaction, and customizable onboarding.
Supports dual-camera, real-time visual/audio transmission
Integrates seamlessly with emergency dispatch systems
Offers AI-based automated activation with on-device inference
Operates in background/PIP mode, increasing stealth
Includes robust fail-safes for connectivity and user error
Facilitates post-event review through secure data archival

The present invention introduces a transformative system for real-time emergency response that integrates user discretion, intelligent automation, and seamless communication. By combining dual-camera live streaming, continuous location tracking, and real-time audio capture within a secure, cloud-enabled ecosystem, the invention empowers users to request and receive assistance without escalating danger or requiring active verbalization.

The incorporation of AI-based threat detection, critical alert delivery through operating system entitlements, and persistent Picture-in-Picture streaming ensures both active and passive scenarios are accounted for, safeguarding users even when they are unable to interact with their devices. Furthermore, the layered architecture—leveraging third-party dispatch APIs, mobile SDKs, encrypted databases, and offline fail-safes—makes the system scalable, reliable, and resilient.

Through flexible configuration options, accessible design for all user demographics, and applicability across diverse real-world environments including rideshare, campus safety, eldercare, and solo travel, the invention stands as a comprehensive personal security solution. It is technologically robust, commercially viable, and positioned to redefine modern mobile safety standards through patent-protected innovation. in emergency communication—discreet, autonomous, and context-rich. It is technically sophisticated yet user-accessible, enabling continuous monitoring and immediate response in life-threatening scenarios without requiring user verbalization or manual intervention.

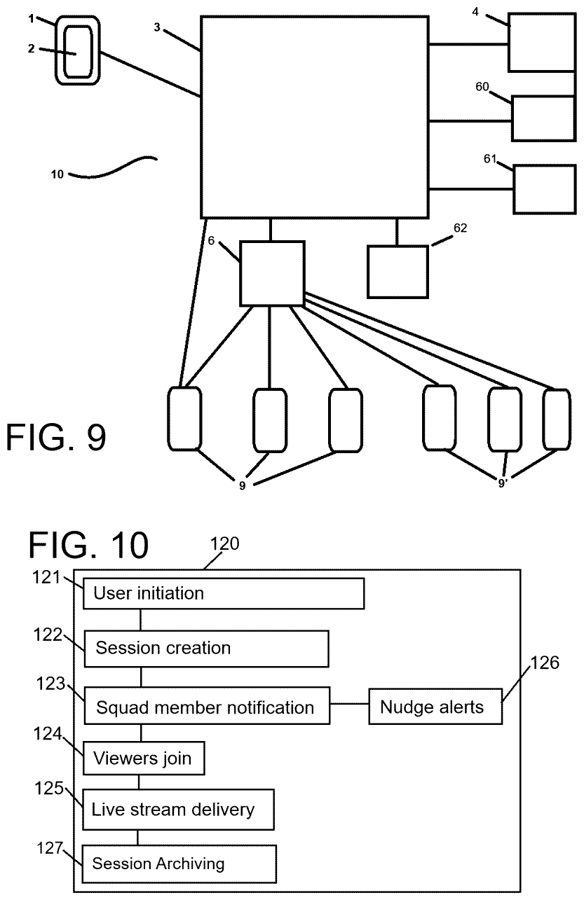

FIG. 9 illustrates a block diagram of the system 10 architecture, having user devices (1), client app (2), backend server (3), media storage (6), transcript service (60), AI summary engine (61), notification service (62), database (4) and end user devices 9, 9′ for “Squad A” and “Squad B”, respectively. The user device may be a computing device having more than one camera, a microphone, and a GPS receiver. The client application 2 may allow a user to set preferences, such as defining one or more Squads. A squad may include a set of members that are contacts of the user, such as friends or family. Squad members may me users of the client application 2, having it installed on their end user devices 9, 9′ such that they can receive notifications via same, or they may simply be people who have an end user device 9, 9′ that may receive notifications via SMS message, email, or other messaging application, and may be provided with a link to view the live broadcast. Squads may be defined in advance, and may be configured to receive notifications automatically when certain events occur, such as the user initiating a live broadcast, or a request for emergency response. For example, a user may define Squad A as friends that they are seeing that night, to be notified when a live broadcast is initiated, and may define Squad B as a parents, significant others, or other family, to be notified in the event they initiate a request for emergency response. The client application may also allow the user to configure additional preferences at the squad level, or individually for squad members, such as a time threshold when a notification times out and a nudge notification should be sent to the member/squad, notification channels (in-app, SMS, email, other applications) to be used for that member/squad, and other useful preferences known in the art or to be developed.

The client application 2 allow a user to initiate a live broadcast session, by providing a “GO LIVE” button or other similar functionality. Upon initiation of a live broadcast session, the client application may capture video from at least a first and second camera of the user device, audio from a microphone, and optionally, GPS data from the GPS receiver. For example, when the user device 1 is a dual camera phone having a front and rear facing cameras, the client application may simultaneously activate both the front and rear facing cameras and capture video from both. Upon initiation of live broadcast, the client application may automatically send push notifications to any pre-defined squads that are marked by the user to receive notifications upon initiation of a live broadcast. The client application 2 may also allow the user to define a new squad to be notified for this particular live broadcast. This may be achieved by allowing the user to select squad members before or after the user hits the “GO LIVE” button or otherwise initiates the live broadcast.

The client application 2 may allow a user to initiate a Trip Mode functionality, specific o live broadcast sessions that will involve traveling from one location to another. In such circumstances, the client application 2 may generate or be provided with a planned route and estimated time of arrival, either by calculating the planned route itself, or through the use of a mapping application, such as GOOGLE® Maps, APPLE® Maps, WAZE® or other mapping application. The client application may also stream and record an actual route as the aggregate of the GPS locations that it receives and streams. The client application may allow the user to initiate an emergency alert, as described above, to request an emergency response from local authorities. The planned route data and ETA may be updated during the trip, as necessary and notifications may be sent out to the extent that the actual route deviates from the planned route past a certain threshold, or to the extent that the ETA changes beyond a certain threshold. These occurrences may also be triggering events for certain squads set by the user to receive notifications about the live broadcast.

The backend server 3 may handle session creation, as described above, coordinating the creation of a broadcast session and controlling the distribution of the video feed to the squad members who are notified to view same. The back end server 3 may issue streaming credentials to the viewers to provide the distributed video only to those users. The back end server 3 ingest the media streams from the user, receiving and storing a copy of same, or may direct the media streams to a video storage service that can be used to distribute both the video streams and the archived video upon completion of the live broadcast. The backend server may receive the audio stream and may further provide same to a transcription service 60. The transcription service may receive and analyze the audio stream and may generate a live transcript of what is said on the audio stream using speech-to-text algorithms and programs. Alternatively, a transcription service may utilize an AI model that is trained to process audio streams and generate a text transcript for them. Similarly, the live broadcast may be provided to an AI model that is trained to process video, audio, GPS location data and/or time stamp data, and to generate a summary description of what takes place during the live broadcast. The AI may further be trained to identify important portions of the live broadcast and to generate a highlight real of such moments. The backend server 3 may also utilize a notification service 62 to generate and send notifications to the users as needed and as described herein. The notification service may initiate and transmit push, SMS, or in-app alerts for live broadcast initiation,, nudge reminders, trip commencement, ETA updates (23), arrival (25), and emergency alerts (33). It also relays live location updates (34).

The data generated from this process may be processed and stored in a database 4. that may be separate from or integrated with the video storage 6. Indeed, persons of skill in the art will recognize that the backend server maybe integrated with the systems (the video storage 6, database 4, transcription service 60, AI summary service 61, and the notification service 62, or some or each of those may be a separate service/model that is communicated with through an API or other suitable communication protocol.

FIG. 10 illustrates a method for distributing a live broadcast session 120 in accordance with the disclosed concepts. The method 120 may include receiving a user initiation 121 of a live broadcast, creating a session 122 for the live broadcast, 123 notifying selected squad members, 124 processing when viewers join, 125 delivering the live stream, sending nudge alerts 126 for squad members who do not join the live broadcast, and session archiving 127. The backend server 3 may receiving the user initiation 121, which may include receiving message from the user's client application 2 that the user has hit the “GO LIVE” button or other suitable communication. This may include a list of squads or squad members to be notified based upon current user input or prior user preferences. Upon receiving such a notification, the backend server may create a session 122, which may include identifying a storage location for the users live broadcast datastreams, beginning recording of same (or coordinating with a video storage location 6 to begin storing same, generating credentials for the user to stream their live broadcast and for the squad members to be notified and view the live broadcast. This may include generation of a persistent link where both the live broadcast and the archived broadcast may be made available. This may further include initiating sessions with the transcription service 60, summarizing AI 61, and notification service 62 to effectuate various features of the live broadcast service as described above.

Once the session is created 122, the backend server may notify squad members 123 that the broadcast is being initiated. This may include initiating notifications to the squad members, in accordance with the initiating user's preferences and/or the receiving squad members' preferences as to how such notifications should be sent. Whenever a user squad member/viewer joins 124, the back end server 3 may record their joining, and may send confirmation to the user that the squad member has joined. Finally, the back end server 3 may check the credentials of joined viewers to ensure that they are authorized to receive the live broadcast. If the squad member/viewer has a client application on their device, the backend server may instruct the squad member's client app 2 to begin accessing or receiving the live broadcast data streams. If the squad member does not have the client application on their end user device 9, 9′, the backend server may provide the squad member with a link to where they may view the live broadcast. If a squad member does not join the live broadcast within a certain time threshold set either by the user or the squad member, the backend server may initiate a nudge notification 126 to remind the squad member that the live broadcast is underway. The user may also be provided with a graphical user interface button to manually send nudge notifications to any squad members that have not yet joined, individually, by squad, or by broadcast session (i.e. to all members of all selected squads who have not yet joined).

Session archiving 127 may include creating and storing a recording of the information streamed during the live broadcast session, and the summaries generated for same. This may include recordings of the first and second video streams, the environmental audio stream, the generated transcript of the environmental audio stream, an AI generated summary of the first and second video streams, and any time stamp data. This may further include storage of messaging during the live broadcast session, and records of which straw members joined the session, when they joined, and which were nudged. The archived session may further be recorded to the squads, or in other words, stored in a manner such that the squads that were invited to participate in the live broadcast session are provided with access to the archived session, while other users are not. This may be accomplished though storing the archived session at a storage location that controls access to the stored data, such that the squad members must log in, or otherwise present credentials in order to access the archived session data. If the squad members are accessing the archived session data from within the client application on their end user device 9, 9′, the access may be managed between the client application and the backend server/video storage service such that it requires no further action from the user or squad member.

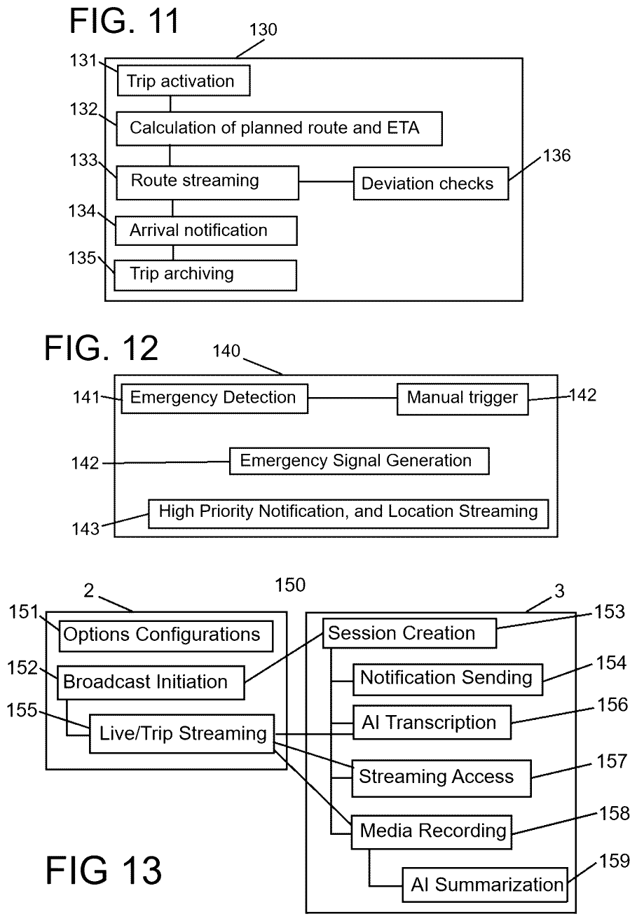

FIG. 11 illustrates a flow diagram for a for initiating a trip mode broadcast 130 in accordance with the disclosed concepts. The method for a trip mode broadcast 130 may include trip mode activation 131, calculation of a planned route and/or eta 132, route streaming 133, arrival notification, 134, trip archiving 135, and deviation checks 136. The user of the client app 2 may initiate a trip mode broadcast by hitting a “TRIP MODE” button, by selecting a “TRIP” or similar option when initiating a live broadcast, or by default, whenever a live broadcast is initiated, unless the user deselects “TRIPMODE” or indicates that it is non-trip broadcast. Trip mode may be enabled at the start of the broadcast, or maybe enabled during the broadcast. The user may further provide a destination location as part of activating trip mode. When the backend server 3 receives a trip mode activation 131, it may create a session 122 as described above, with additional features or functionality enabled to display the user's location together with the live broadcast. This may involve communicating with and establishing credentials with a map service. Upon trip mode activation 131 the backend server may compute a planned route and estimated time of arrival (ETA) 132, or may communicate with a mapping service to obtain a planned route and ETA. Alternatively, the trip mode activation request may provide same, particularly in implementations where the client application is integrated with a ride share mapping application. The backend server may then notify squad members of the trip mode broadcast as above 123, and begin route streaming, which may include tracking the GPS locations provided by the user, and displaying those locations overlayed on a map at the same time as the data streams are being presented. Accordingly, during transit, the user's client app 2 streams the route 133 together with the dual-camera video and audio streams, updating server as to their progress in the trip. Upon arrival, the client may issues an Arrival notification 134 and ends session. The backend server may then archive the trip mode session, or initiate archiving of same using the appropriate services. The archival of the trip mode broadcast may include storing the video, audio, route data, audio transcript, and AI video summary, as discussed above. It may further include time stamp data, and align all data streams to be presented chronologically. Either or both of the client application 2 and backend server may initiate deviation checks periodically or if the planned route or ETA are changed beyond a threshold that may be set by the user or may have default settings. This may prompt the user with a status check to ensure that they are ok, or it may prompt an administrator to review the data stream for potential signs of trouble.

FIG. 12 illustrates a flow diagram for a method for initiating an emergency alert 140 in accordance with the disclosed concepts. Method 140 may include emergency detection 141 manual trigger 142, emergency signal generation 143; and issuing a high-priority squad alert 144 with live location link to all selected Squads until cancellation. Emergency detection 141 may occur on the client app 2, on the back end server 3, on separate specialized AI trained to detect emergency from video and audio feeds, as discussed above, where the system, whether by using an AI as described above, or a software system encoded to process video and audio streams to detect an emergency detects danger sufficient to trigger an emergency response signal. Similarly, manual trigger 142 may include the user triggering a request for emergency services, an administrator viewing the broadcast and initiating such a response, or a squad member watching the broadcast triggering an emergency signal. In the latter cases the user may be provided with a notification that someone has initiated an emergency response request, and may be provided with an opportunity to cancel same. When such a request is made, the back end server may handle it as described above, and route the request to an emergency dispatcher 75 with the local authorities or to an emergency services provider 7 which handles such requests.

FIG. 13 illustrates a flow diagram for a system 150 for live broadcasting and archival in accordance with the disclosed concepts. The system may include a client app 2 and a backend server 3. The client app may allow a user to configure options 151, initiate a broadcast 152, and engage in live streaming or trip streaming. The backend server 33 may facilitate same by creating a broadcast session 153, sending notifications 154 to the appropriate squads, engaging AI transcription 156 (or other transcription services), providing the appropriate users with access to the live streaming or trip streaming 157, ensuring that the broadcast media is recorded 158, and providing the recording to a AI trained to analyze and summarize the broadcast 159. The client app 2, may allow the user to set configuration options, as discussed in greater detail above, including creating squads, setting preferences for how and when those squads should receive notification of the broadcast, which may include whether they are provided with the livestream or with a time-delayed copy of same (for example, some users may be provided with live access while others may be delayed by a set amount of time (10 seconds, 1 minute, 1 hour, etc.) depending on the type of stream and the reasons for the delay (user safety, providing premium members with early access, etc.). The client app 2 also allows the user to initiate a live stream or a trip stream 152, which may include streaming with one or more cameras simultaneously, streaming environmental audio, streaming a prerecorded soundtrack or background sounds/music, streaming location information, including time stamps, and any other information which a user may wish to convey. Once the client app 2 receives confirmation that the session 153 has been created from the backend server, the client app 2 may then stream the selected data streams for the live stream or trip stream 155.

The backend server may create a session 153, as described above in greater detail. Once the session is created 153 it may communicate the success of creation to the client app 2, and may begin sending notifications 154 to the appropriate squads. The backend server 3 may provide the live/trip stream audio stream to a transcription service, such as an AI transcription service 156 for live transcription of words detected in the audio stream. The backend server may also manage streaming access, providing notifications and appropriate access to end users in accordance with the streaming user's preferences and settings. Once the live/trip stream has ended, the backend server 3 may store, or coordinate the storage of, a recording of the live/trip stream 159. The recording may be provided to an AI trained to summarize the broadcast data, or the AI may be provided with access to the streams to begin generating the summary during the live/trip stream. Each of the backend server's 3 tasks may be done directly by the backend server 3 or through communication with services, such as a notification service 62, a transcription service 60, a video storage 6 and database 4, and an AI summarization service 61.

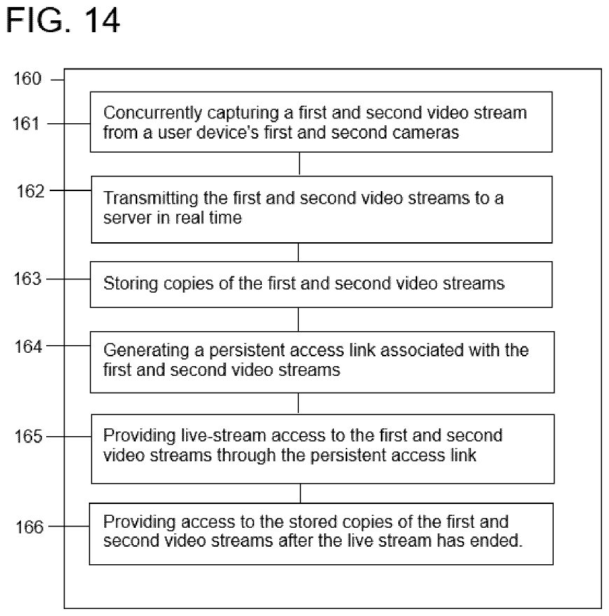

FIG. 14 illustrates a flow diagram for a method for continuous video recording and live broadcasting 160. The method may include concurrently capturing a first video stream concurrently from a first camera of a user mobile device, and a second video stream from a second camera of they user mobile device 161, transmitting the first and second video streams in real time to a server 162; storing copies of the first and second video streams 163; generating a persistent access link associated with the first video stream and the second video streams 164; providing live-stream access to first and second video streams through the access link 165; and providing to the stored first and second video streams using the same access link after the live-stream has ended 166.

Capturing a first video stream concurrently from a first camera of a user mobile device, and a second video stream from a second camera of they user mobile device 161 may include providing an application that runs on a user mobile device, such as a smart phone, that has at least two cameras, such as a forward-facing camera and a rear-facing camera. The application may be configured to activate both cameras at the same time and to encode a video stream the video stream may be encoded with any suitable algorithm known in the art or to be developed, including but not limited to H.264, H.265, or VP9. Similarly, transmitting the first and second video streams in real time to a server 162 may be implemented by the same application establishing a connection to the server through any suitable protocol known in the art or to be developed, to send both video streams as they are being recorded in packets, or in any other suitable manner. Storing copies of the first and second video streams 163 may be accomplished server side, or may be performed on the user device for later transmission of the full video to the server. Regardless of whether the storing is done server side or mobile device side, the stored copies may be further processed and encoded to desired levels of compression and quality. Similarly, generating a persistent access link associated with the first and second video streams may be performed server side, or may be coordinated from the user mobile device application to create a persistent url, or other suitable link, where the live stream of the first and second video streams may be accessed, and where the same url or link may be used after the live stream has ended.

Once the persistent access link has been created, the server may provide live stream access through the first and second video streams through the persistent access link 165 while the streams are being recorded. This first and second video streams may be presented in split screen fashion, side by side for vertical video layouts, or one above the other for horizontal video layouts. Alternatively, the two video streams may be presented in picture-in-picture format, and the viewer may be provided with a user interface the persistent access link by which he can change the focus of the picture-in-picture display from one stream to another. The user interface may also allow a user to switch between a split-screen view, to a picture in picture view, to a single-camera/stream view, or any combination thereof. For embodiments with augmented reality the interface may allow the viewer to toggle such features or information on and off. Additionally, in embodiments with metadata, such as time stamps and/or location information, those may be displayed together with the video streams, either within the video streams or adjacent to the video streams, and the user interface may allow a user to toggle what information is displayed and how it is displayed. For example time stamps may be displayed with a text overlay over one or both videos, or above, below or adjacent to one or both videos, or not at all. A map showing location information may similarly be displayed adjacent to, or as a picture-in-picture in a selected location of one or both videos. The same persistent access link may be used to provide access to the stored copies of the first and second video streams after the live stream has ended 166. The same viewing an meta data options may be presented to a viewer with respect to the stored copies of the completed video streams.

### System Components

Mobile Device: Equipped with camera(s) capable of simultaneous dual-camera video recording or just a one way camera.
Custom System/Server (3rd-i Server): Configured to receive, store, and manage live and recorded video streams.
Access Interface: A web-based or app-based platform that allows users to access live and archived broadcasts via a unique, persistent link.

### Operational Methodology

Video Capture: The mobile device captures video and simultaneously uploads the footage to the server in real-time.
Broadcasting: Users can broadcast live video streams which are accessible through a custom or predefined URL.
Persistent Access Link: A unique URL is generated for each video session, which remains valid for accessing both the live broadcast and the archived video post broadcast.
Dual Camera Functionality: During the broadcast, the host can activate a dual camera mode, displaying two simultaneous video feeds in a split-screen format on the viewer's interface.
Post-Broadcast Access: After the live session ends, the video is stored on the server and remains accessible through the same URL used for the live broadcast.
Additional Features: Video summary generation and audio breakdown are optional features that can be integrated to enhance content accessibility and analysis.

### Use Cases

Live Event Coverage: Users can live stream events, and viewers can access the broadcast in real-time or revisit the archived video through the same link. The dual camera ability adds to the experience.
Sharing Long Videos: Using the shareable link, a recorded broadcast lasting up to hours can be accessed within seconds. If the user streamed with a dual camera setup, the recipient or viewer of the video will also be able to experience it in dual camera mode.
Project Management & Client Collaboration: Professionals can share a live or recorded stream of meetings, walkthroughs, or on-site inspections with clients or team members via a persistent link. The dual camera feature allows simultaneous viewing of the presenter and the subject matter (e.g., product demos, design layouts, construction progress). Integrated messaging during the stream fosters real-time feedback and collaboration, enhancing remote engagement and project transparency.
Real Estate Tours: Realtors can livestream property walkthroughs to clients who cannot attend in person. With the dual camera mode, clients can see both the realtor and the property simultaneously, allowing for a more personalized and interactive experience. This real-time communication ensures buyers receive context and explanations as they view the home, improving decision-making from a distance.
Field Reporting and Journalism: Reporters can livestream news from the field while showing both themselves and what's happening around them. Viewers get context from the reporter and visuals from the scene, all accessible via a single link for both live and replay.
Customer Support & Troubleshooting: Tech support teams can guide customers through setup or problem-solving via livestream. One camera shows the customer or technician, and the other shows the product or issue, allowing for clearer support and remote assistance.
Fitness and Wellness Coaching: Personal trainers or wellness coaches can run live sessions where one camera captures their face (for communication) and the other captures the exercise or technique being demonstrated. Clients can watch live or later via the same link.
Security Monitoring and Check-ins: Individuals or businesses can stream security footage to remote viewers. For example, a delivery driver or security officer can use dual cameras to show both their face and their surroundings while patrolling or entering a location.
Content Creation & Influencer Marketing: Content creators can stream behind-the-scenes footage while simultaneously addressing their audience. This enhances authenticity and engagement. The persistent link makes it easy to reshare or archive the content.
Legal or Insurance Documentation: Dual camera livestreams can be used for remote walkthroughs of damage (e.g., property, vehicle) while narrating or showing identification. The persistent link ensures easy sharing with claims adjusters, lawyers, or insurers.
Virtual Tours and Museum Guides: Museums, galleries, or travel companies can offer livestreamed guided tours with a docent visible on one camera and the exhibits on the other. Viewers can join remotely and revisit the experience afterward using the same link.
Remote Learning & Student Projects: Students can present projects, science experiments, or performances remotely using dual camera mode—showing themselves presenting and their work simultaneously. Teachers and peers can watch live or later via the link.
Remote Interviews and Hiring: Companies can use the system to conduct and share interviews where the candidate and the interviewer are both visible in dual camera mode, with the session saved and shareable via a single link for other stakeholders to review.
Educational Workshops: Instructors can utilize the dual camera functionality to provide multiple perspectives during live tutorials.
Personal Broadcasting: Allows individuals to share moments with friends and family, who can join live or watch later using the shared link.
Doctor's Appointment Broadcasting: This feature enables individuals to share their medical consultations with friends and family. Loved ones can join the appointment live or view it later through a shared link. This accessibility helps those who cannot be present understand the details of the medical visit, ensuring they are informed and can provide support regardless of their physical location.
Driving Broadcast or (drivestream): This feature enables individuals to share their driving experiences with friends and family. Loved ones can join live or view recordings via a shared link. The dual camera allows friends and family to view both camera angles, the driver and the road ahead. This functionality is perfect for those who want to keep an eye on drivers to ensure their safety throughout their journey.

The present invention thus provides a method and apparatus for real-time video uploading and broadcasting comprising: capturing video using a mobile device; simultaneously uploading the video to a server; generating a persistent access link for said video; enabling live access and post-broadcast access via the same link. The video capturing method and apparatus may further include dual camera functionality, providing a split-screen view on the user interface.

The present invention significantly improves the user experience in video broadcasting by simplifying the process of accessing live and archived content through a single, unchanging link, while offering advanced features such as dual-camera functionality and video analytics.

Through flexible configuration options, accessible design for all user demographics, and applicability across diverse real-world environments including any circumstances in which a user may wish to broadcast information, and particularly in situations where the broadcast encompasses a trip and where safety is a concern.

While the invention has been described with reference to specific embodiments and examples, it will be understood by those skilled in the art that various changes may be made and equivalents may be substituted without departing from the scope of the invention. In addition, many modifications may be made to adapt a particular situation, material, composition of matter, method, or process step to the objective, spirit, and scope of the present invention. All such modifications are intended to be within the scope of the claims appended hereto.

We claim:

1. A method for broadcasting live multimedia to predefined social groups (squads), comprising:
selecting one or more squads in a client application, each of the squads comprising one or more members;
initiating a live broadcast session capturing and transmitting a first and second video streams from a first and second camera and an environmental audio stream;
initiating a push notification to members of the selected one or more squads; and
upon termination of the live broadcast session, archiving the live broadcast session comprising storing a recording of the video streams and audio stream, a text transcript, and an AI-generated summary.

2. The method of claim 1, wherein the first and second cameras comprises front-facing and rear-facing camera, and wherein the first and second video streams are captured simultaneously.

3. The method of claim 1, further comprising engaging trip mode, comprising
specifying current location and a destination;
computing an estimated time of arrival;
transmitting a GPS location stream and corresponding time stamp stream as part of the live broadcast session;
notifying the selected squads of trip start and the estimated time of arrival;
streaming real-time trip updates showing an actual route made from the GPS location stream as part of the live broadcast session; and
issuing an arrival notification upon reaching the destination; and
wherein the archiving the live broadcast session further comprises archiving a trip recording, comprising the planned route, and the actual route, the gps location stream and the corresponding time stamp stream;
wherein the selected squads are provided access to the archived broadcast session including the trip recording.

4. The method of claim 1, further comprising issuing an emergency alert during the session that dispatches a high-priority notification with live location and stream access links to the selected squads.

5. The method of claim 1 further comprising generating and associating a persistent access link with the live broadcast such that during the live broadcast the persistent access link provides access to the live broadcast, including the first and second video streams, the environmental audio stream, and after the live broadcast session, the persistent access link provides access to the archived broadcast, including the recording of the video streams and audio stream, the text transcript, and the AI-generated summary.

6. The method of claim 3 further generating and associating a persistent access link with the live broadcast session such that during the live broadcast the persistent access link provides access to the live broadcast session, including the first and second video streams, the environmental audio stream, the planned route, the actual route, the GPS location stream and corresponding time stamp stream, and after the broadcast session, the persistent access link provides access to the archived broadcast, including the recordings of the first and second video streams and the audio stream, and the actual path, the GPS location stream and corresponding time stamp stream.

7. The method of method of 5 wherein the persistent access link presents the first and second video streams in a dual-camera split-screen format.

8. The method of claim 1, further comprising a messaging interface that allows real-time communication between the broadcaster and squad members.

9. The method of claim 8, further comprising allowing viewers to react or respond via the messaging interface during the live stream.

10. The method of claim 1, further comprising receiving confirmation when the members of the selected squads join the live broadcast session, and providing a user interface button for initiating a secondary nudge alert to the members of the selected squad who have not joined the broadcast session.

11. The method of claim 1, further comprising receiving confirmation when the members of the selected squads join the live broadcast session, and issuing a secondary nudge alert to the members of the selected squad who do not join within a configurable time threshold;

12. The method of claim 5, wherein the persistent access link includes an optional expiration timestamp or access token.

13. The method of claim 1, wherein the application is further configured to record timestamp metadata during the video session.

14. The method of claim 1, further comprising generating a summarized video highlight reel using artificial intelligence.

15. The method of claim 5, wherein access permissions for the persistent link are managed through a user account.

16. The method of claim 1, wherein a viewer interface provided with the persistent access link allows switching between single and dual-camera viewing modes.

17. The method of claim 1, further comprising using edge computing or local caching to reduce latency in long-duration video playback.

18. The method of claim 1, wherein the first and second video streams are displayed side-by-side in a split-screen format on a web or mobile interface.

19. The method of claim 1, wherein the first and second video streams are displayed in picture-in-picture format|on a web or mobile interface.

20. A system for social live broadcasting, comprising:
a client application installed on a user device, the client application configured to capture dual-camera video, audio, and GPS location;
a backend server configured to manage session credentials, direct media streams, generate speech-to-text transcripts and AI summaries, and store session data;
a notification service configured to send push, SMS, and in-app alerts for the initiation of a live broadcast, nudge alerts, trip alerts, arrival alerts, and emergency events; and
a data store for persisting recorded media, transcripts, summaries, and route data.
